(19) United States
(12) Patent Application Publication
(10) Pub. No.: US 2018/0221840 A1
(43) Pub. Date: Aug. 9, 2018

(54) Automated Systems and Methods to Facet and Polish Diamond for Productization

(71) Applicant: Bobbie Celler, Manhattan Beach, CA (US)

(72) Inventor: Bobbie Celler, Manhattan Beach, CA (US)

(21) Appl. No.: 15/890,067

(22) Filed: Feb. 6, 2018

Related U.S. Application Data
(60) Provisional application No. 62/456,089, filed on Feb. 7, 2017.
(60) Provisional application No. 62/457,975, filed on Feb. 12, 2017.

(51) Int. Cl. B01J 3/06; G01N 21/87

(52) U.S. Cl. CPC B01J 3/062; C01B 32/25; B01J 3/065; G01N 21/87

(57) ABSTRACT

Systems and methods are directed to selecting unpolished regular-polygonal diamonds; selecting diamond powder based on size, profile and hardness to use as acceleration media; and polishing the regular-polygonal diamonds by accelerating at least the diamond powder using a plurality of spray patterns determined as a function of the respective hardnesses of the diamond powder and the unpolished regular-polygonal diamond, the spray patterns directed at the unpolished regular-polygonal diamonds. The method further includes accelerating the regular-polygonal diamonds and the diamond powder to create the spray patterns; directing the spray patterns so that they overlap causing the diamond powder to polish the regular polygonal diamonds; separating the regular-polygonal diamond from the diamond powder; and repeating the steps of accelerating the regular polygonal diamonds and the diamond powder and the separating until the regular-polygonal diamond is polished.

### CROSS-REFERENCE TO RELATED APPLICATIONS

The present application is a non-provisional filing of, and claims benefit under 35 U.S.C. § 119(c) from, U.S. Provisional Patent Application Ser. No. 62/456,089, filed Feb. 7, 2017, entitled “AUTOMATED SYSTEMS AND METHODS FOR FACET AND POLISH DIAMONDS FOR PRODUCTIZATION”, and U.S. Provisional Patent Application Ser. No. 62/457,975, filed Feb. 12, 2017, entitled “AUTOMATED SYSTEMS AND METHODS TO FACET AND POLISH DIAMOND FOR PRODUCTIZATION”, all of which are hereby incorporated in its entirety.

### SUMMARY

Disclosed are systems and methods to polish lab-grown diamonds using automated means. Further disclosed are products that incorporate polished, lab-grown diamonds.

More specifically, a method, according to an embodiment is directed to selecting unpolished regular-polygonal diamonds; selecting diamond powder based on size, profile and hardness to use as blast media; and polishing the regular-polygonal diamonds by accelerating at least the diamond powder using a plurality of spray patterns determined as a function of the respective hardnesses of the diamond powder and the unpolished regular-polygonal diamond, the spray patterns directed at the unpolished regular-polygonal diamonds.

In accordance with the embodiment, the method further includes accelerating the regular-polygonal diamonds and the diamond powder to create the spray patterns; directing the spray patterns so that they overlap causing the diamond powder to polish the regular polygonal diamonds; separating the regular-polygonal diamond from the diamond powder; and repeating the steps of accelerating the regular polygonal diamonds and the diamond powder and the separating until the regular-polygonal diamond is polished.

In one embodiment the accelerating uses a cylindrical wheel blaster. In another embodiment, the accelerating uses pneumatics supplied by an air source.

In one embodiment, the accelerating the regular-polygonal diamonds and the diamond powder enables at least a portion of the diamond powder or the regular-polygonal diamonds to reach up to 300 Kelvin degrees. Further, in an embodiment, the accelerating the regular-polygonal diamonds and the diamond powder occurs in a de-pressurized area to prevent oxidation and prevent catalysis of the diamond to transition from diamond to graphite.

In one embodiment, the accelerating the regular-polygonal diamonds and the diamond powder reaches velocities in meters per second of between 20 and 60.

Another embodiment is directed to an apparatus including one or more of tattoo ink, paint, lipstick, makeup, alcohol, and perfume containing polished, lab-grown, regular-polygonal diamonds.

### BRIEF DESCRIPTION OF THE DRAWINGS

A more detailed understanding may be had from the following description, presented by way of example in conjunction with the accompanying drawings, wherein:

FIG. 1A shows a diagrammatic view that illustrates a diamond polishing machine that accelerates two streams of diamonds using centrifugal wheel blasters such that the spray patterns overlap causing the diamonds to polish.

FIG. 1B is a flow diagram illustrating a method in accordance with an embodiment.

FIG. 2 shows a front view that illustrates a bottle of alcoholic beverage with diamonds contained within the bottle.

FIG. 3 shows a perspective view that illustrates soap having faceted and polished diamonds that act as an exfoliating agent.

FIG. 4 shows a diagrammatic view that illustrates a tattoo artist using tattoo ink that contains faceted and polished diamonds sized to be absorbed by skin cells.

FIG. 5 shows a side view that illustrates a tattoo drawn with tattoo ink containing faceted and polished diamonds

FIG. 6 shows a perspective view that illustrates a paint can with paint that contains faceted and polished diamonds in suspension.

FIG. 7 shows a diagrammatic view that illustrates a woman applying makeup and personal care products that contain faceted and polished diamonds.

FIG. 8 shows a perspective view that illustrates body glitter that contains faceted and polished diamonds.

FIG. 9 shows a perspective view that illustrates hairspray that contains faceted and polished diamonds.

FIG. 10 shows a perspective view that illustrates lipstick that contains faceted and polished diamonds.

FIG. 11 shows a diagrammatic view that illustrates a diamond polishing machine that accelerates two streams of diamonds using pneumatics such that the spray patterns overlap causing the diamonds to polish.

FIG. 12 shows a perspective view that illustrates perfume or cologne that contains is faceted and polished diamonds.

FIG. 13 shows a perspective view that illustrates finger nail art jewels that are faceted and polished diamonds having one side contoured to adhere to the finger nail.

### DETAILED DESCRIPTION

A detailed description of illustrative embodiments will now be provided with reference to the various Figures. Although this description provides detailed examples of possible implementations, it should be noted that the provided details are intended to be by way of example and in no way limit the scope of the application.

Traditionally, diamonds have been rare finds. They are mined; cut and polished by artisans; and treasured as heirlooms by their owners. Over the past few decades, technology has advanced to allow growing quantities of diamonds using machines, and, will soon outpace diamonds produced through mining.

There are a variety of methods of growing diamonds, including HPHT (High Pressure High Temperature, any press type), CVD (Chemical Vapor Deposition), 25 and recently explosive formation and sanitation of graphite solutions. When growing diamonds, the method can be tweaked to control the crystalline structure, color, thermal-conductive characteristics, electrical-conductive characteristics, shape, size, and other characteristics. As such, diamonds can be grown to suit a particular purpose. The global capability and capacity of synthetic diamond manufactures will soon outpace the production of the world's mined diamonds.

Use of relatively small diamonds in large quantities has been prohibitive because of the prohibitive cost of cutting and polishing each diamond. Applicants describe the automated faceting and polishing of diamonds, even for diamonds of a very small sizes. Applicants further describe the use of such diamonds in a variety of consumer product where the products are enhanced through the introduction of diamond.

In some cases, the size of the diamonds to be grown and polished are small, compared to mined diamonds. For example, depending on the application, the size can be as small as 5 microns. Faceting and polishing such small diamonds by hand is impractical.

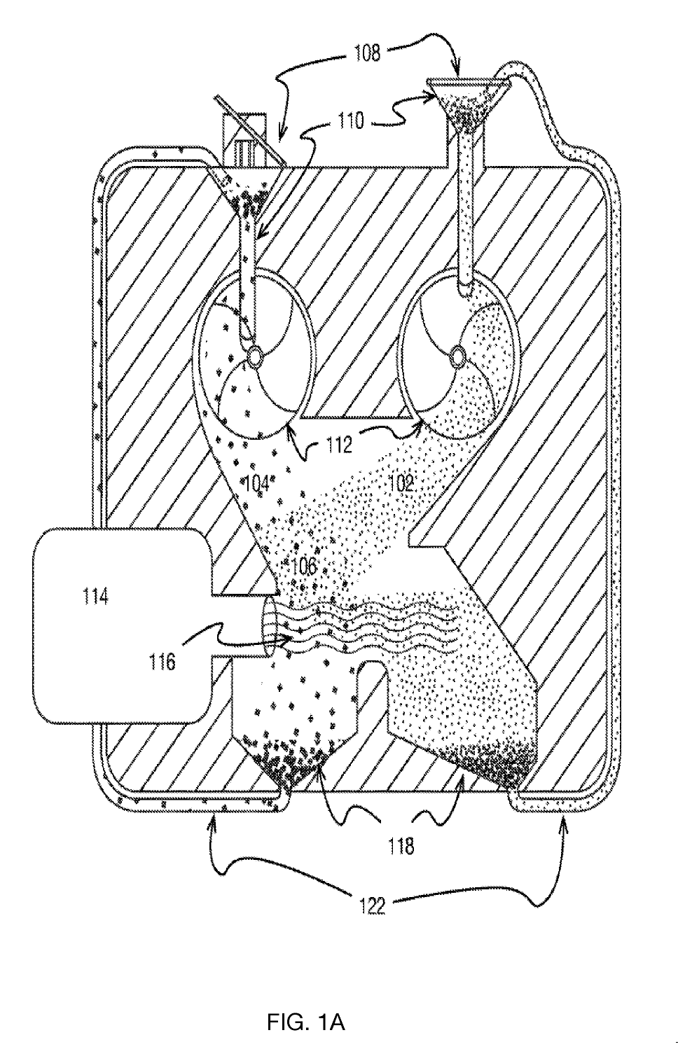

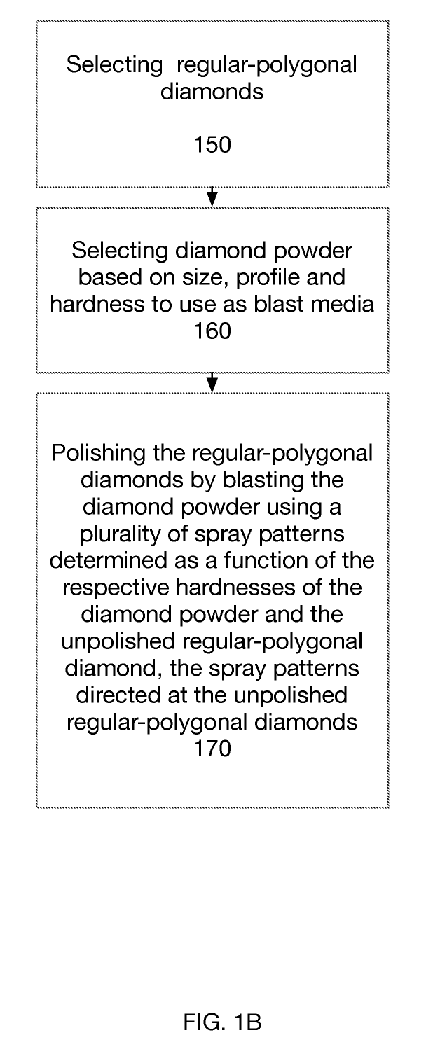

FIG. 1A shows a diagrammatic view that illustrates a diamond polishing machine 100 that accelerates two streams of diamonds 102 &104 such that the spray patterns overlap (in area 106) causing the diamonds to polish. In some embodiments, the two streams of diamonds consist of diamonds grown identically. As shown, the two streams of diamonds consists of diamonds grown differently. Stream 102 consists of diamond powder grown to select hardness, size, profile and other characteristics to optimize for polishing other diamond. When growing diamond powder to use as an abrasive to polish diamonds, the diamond powder is designed for abrasiveness, powder, speed of intended blasting, profile, and size. Stream 104 consists of diamonds that have been grown to select color, clarity, size, shape, and hardness to optimize for the intended product use. In one embodiment, the diamond powder would be sized to be a fraction of the size of the diamond desired for incorporation into a commercial product; the diamond powder would be grown as harder than the diamonds to facilitate polishing; the diamond powder would have a profile effective to polish other diamonds. In one embodiment, the diamonds are grown to have a particular, regular polygonal shape. This regular polygonal shape can have relatively flat surfaces that become the “facets” of the diamond, after polishing. Said another way, diamonds can be grown such that relatively flat areas are available for polishing, without cutting the diamond. The number of relatively flat areas can also be selected through the use of appropriate diamond seeds. As used in this specification “faceted” means flat areas of diamond that occur during growth, rather than, flat areas that occur due to cutting, except where explicitly described otherwise.

The size of the diamond powder can be from 0.1 microns to upwards of 100 microns in size depending on the diamonds to be polished and faceted and the grade of the diamond powder, Standard grade (SDM), Premium grade (PDM), or Economical grade powders (EDM), as will be appreciated by one of skill in the art.

The diamonds can be loaded into the diamond polishing machine 100 through sealable hatches, as shown. In an embodiment, the entire diamond polishing machine is sealed to prevent diamonds, diamond powder, or smaller particles from exiting the machine. Hoppers 110 can be adjusted to position relative to the centrifugal wheel blasters 112, as shown. The position of hoppers 110 can be adjusted to create a desirable spray pattern, for example, wider or narrower. Wheel blaster 112 spin quickly to accelerate the diamond and diamond powder to relatively high velocity. The speed of rotation of the wheel blaster is selected to determine spray pattern, finish quality, and other characteristics of polishing by blasting.

After colliding in the overlapping spray pattern area 106, the diamond and diamond powder will fall, by gravity. An air separator 114 pneumatically separates the larger, heavier diamond from the smaller, lighter diamond powder using a jet of air 116. The speed of the jet of air 116 can be selected to efficiently separate the diamond from diamond powder. The collection chambers 118 separately collect the diamond from the diamond powder after separation, as shown. After collection, the diamonds and diamond powder return to the hoppers 110 using conveyors, as shown, of any convenient type. Diamonds run through the machine multiple times, until the desired clarity and polish is achieved, preferably, without rounding the diamond completely.

In other embodiments, other kinds of separators are used, for example, shifters, color separators (when using different color diamonds and diamond powder), etc. In another embodiments, diamonds are polished using related methods. In a further embodiment, diamonds are polished using a single stream of blasting instead of two streams. Alternately, diamonds are polished using multiple streams, that is, more than two.

Referring to FIG. 1B a flow diagram illustrates a method in accordance with an embodiment. As shown, block 150 provides for selecting regular-polygonal diamonds. Such diamonds can be grown from seed or provided. Block 160 provides for selecting diamond powder based on size, profile and hardness to use as acceleration (blast) media. Block 170 provides for polishing the regular-polygonal diamonds by blasting the diamond powder using a plurality of spray patterns determined as a function of the respective hardnesses of the diamond powder and the unpolished regular-polygonal diamond, the spray patterns directed at the unpolished regular-polygonal diamonds.

The blasting or “accelerating” the diamonds and/or diamond powder herein described not only requires streams of diamond powder, but in order to increase the coefficient of friction to a point that enables appreciable results, the diamond on diamond friction can include a water component akin to sand blasting equivalent pressures without reaching frictional anisotropy which would cause a diamond to transform into a lower-order carbon structure. In one embodiment, the blasting enables at least a portion of the diamonds to reach 550-600 K degrees. In another embodiment, the temperature of the diamonds do not exceed 300 K degrees. In one embodiment, the blasting occurs in a de-pressurized area to prevent oxidation and avoid catalysis of the diamond to transition from diamond to graphite. In one embodiment, the blasting includes linear velocities in meters/sec of between 20 and 60 m s⁻¹. Importantly, during blasting, in one embodiment, not all the diamonds are required to be polished and waste is assumed to occur. However, depending on the temperature, pressure and linear velocity, as well as the hardness of the diamond to be polished, the amount of waste can be minimized.

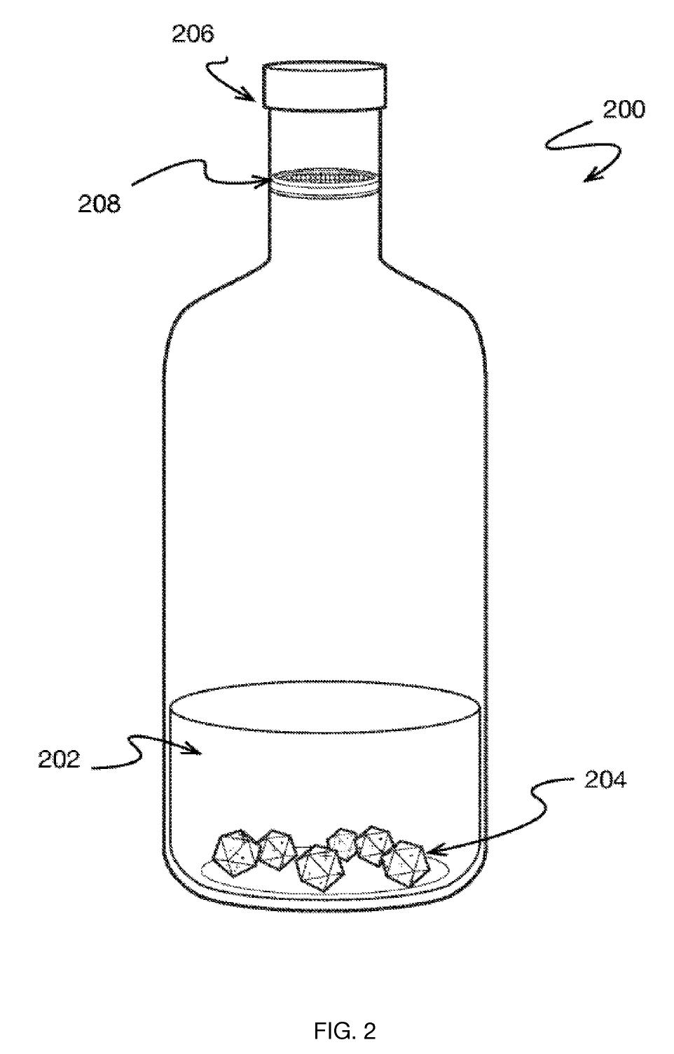

FIG. 2 shows a front view that illustrates a bottle 200 of alcoholic beverage 202 with diamonds 204 contained within the bottle 200. The diamonds are grown to have attributes that filter the alcoholic beverage, for example, diamonds are capable of removing certain ions from the beverage, thereby having an impact on flavor. Bottle 200 can be fitted with a cap 206 and a filter 208. The filter 208 prevents the diamonds 204 from pouring out of the bottle. Diamonds 204 are fated and polished diamonds, as shown. In certain embodiments, diamond 204 are rough diamonds. In one embodiment, the alcoholic beverage is vodka.

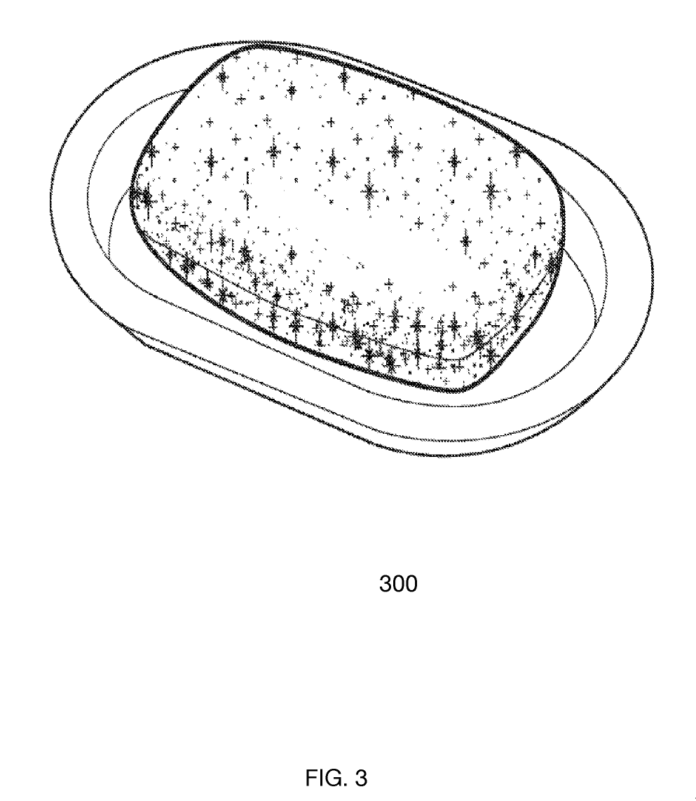

FIG. 3 shows a perspective view that illustrates soap having faceted and polished diamonds that can act as an exfoliating agent. The soap contains a concentration of faceted and polished diamonds. The diamonds are sized to work effectively as an exfoliating agent. The soap cleans and exfoliates skin during use.

In another embodiment, the soap is liquid soap and the concentration of diamonds are suspended in the soap solution.

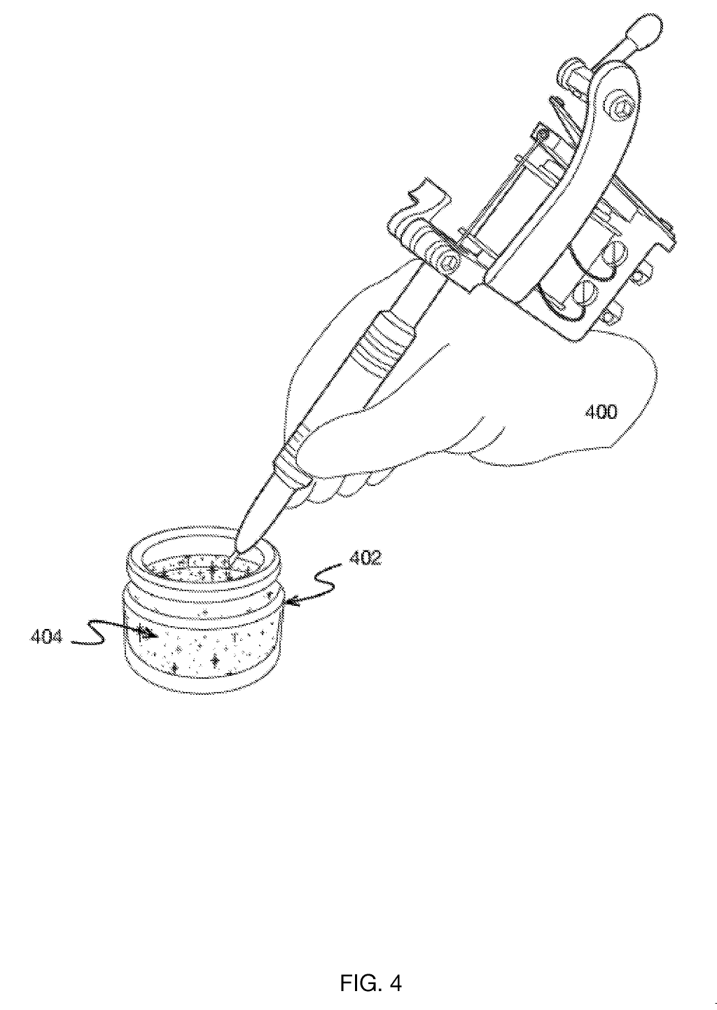

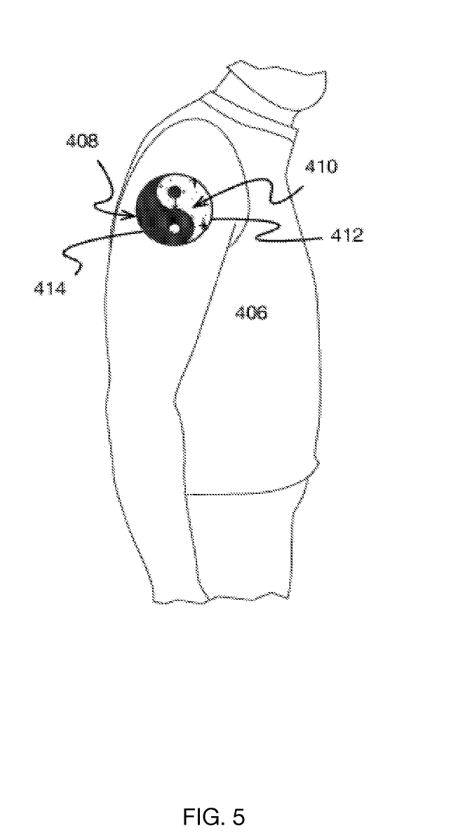

FIG. 4 shows a diagrammatic view that illustrates a tattoo artist 400 using tattoo ink 402 that contains faceted and polished diamonds 404 sized to be absorbed by skin cells. FIG. 5 shows a side view that illustrates a tattoo 408 drawn with tattoo ink 404 containing faceted and polished diamonds 410 which have been absorbed but not metabolized by the skin cells. In some embodiments, the diamonds are sized as large as possible while still allowing absorption, such that, diamonds do not leak through small opening in skill cell outer membranes. Skin is translucent, allowing the pigment from the tattoo ink to be visible through the outer most layers of skin. Likewise, light can reflect from the diamonds back through the skin creating luminance and brilliance. The proportion of diamonds to tattoo ink is selected to determine overall perceived luminance brilliance. For example, in the tattoo 408 shown, the black area 414 does not contain diamonds, while, the white area 412 does contain diamonds. This configuration transforms a classic tattoo of the yin-yang symbol, because, typically the white area of the symbol is merely outlined, and, color is implied by the skin tone without pigmentation from tattoo ink. When using diamond-infused tattoo ink, a white colored pigment has additional luminance and brilliance from the diamonds, thereby contrasting better with the black areas. Black areas, as shown, do not have diamonds infused with the black tattoo ink pigment. In other embodiments, black areas are infused with diamond. The varying intensity of pigmentation across various colors of tattoo inks requires varying concentrations of diamonds to produce uniform brilliance and luminosity across a single tattoo. In one embodiment, the tattoo ink does not contain pigment, but rather, is merely the diamonds in solution suitable for delivery to the sink cells through the tattoo needle. As such, a method of using diamond-infused tattoo ink allows the tattoo artist to vary the concentration of diamond to create artist effect, that is, greater or lesser luminance and brilliance across the tattoo art, thereby providing an additional dimension to the artistic possibility of tattoo art.

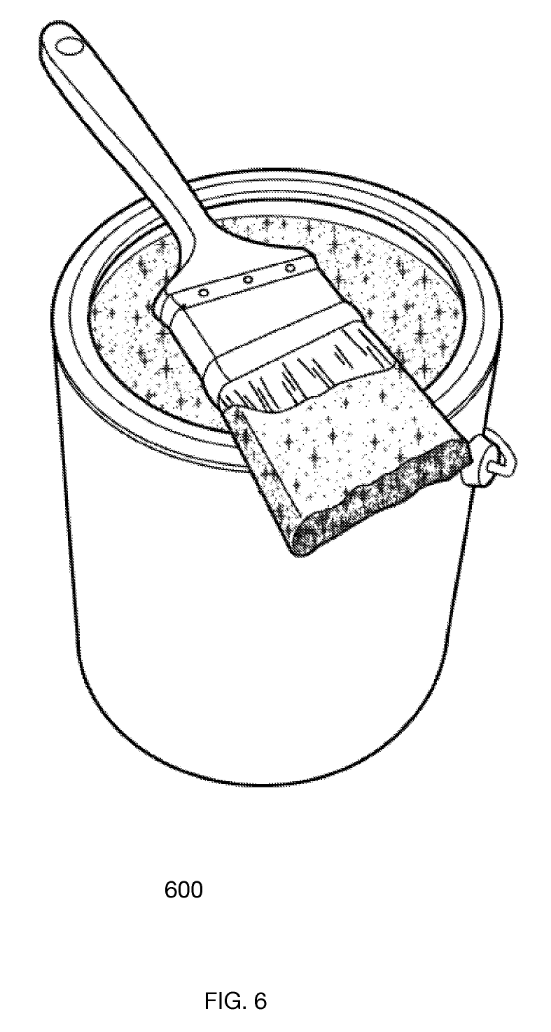

FIG. 6 shows a perspective view that illustrates a paint can 600 with paint that contains faceted and polished diamonds in suspension. The size of the diamonds and the concentration of diamonds is selected for desired luminosity and brilliance after the paint dries.

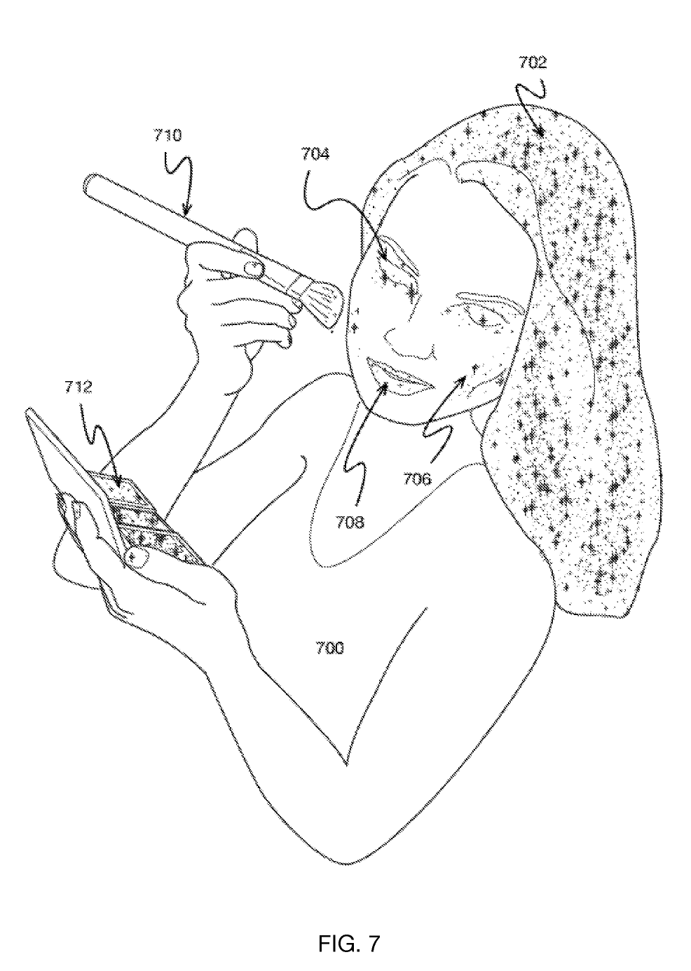

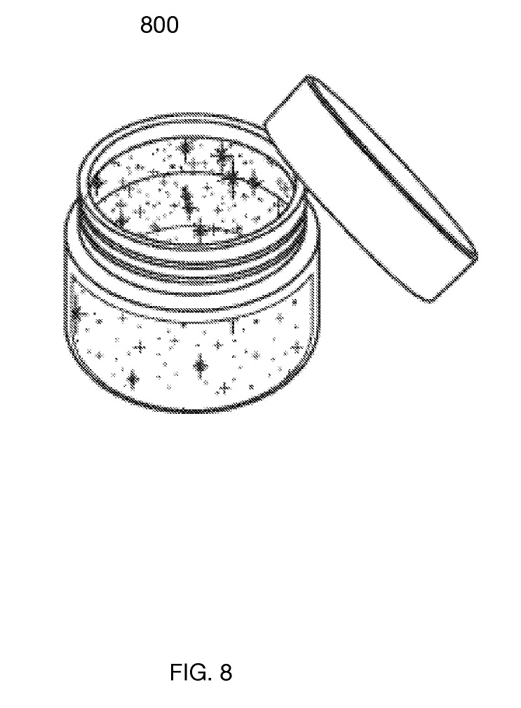

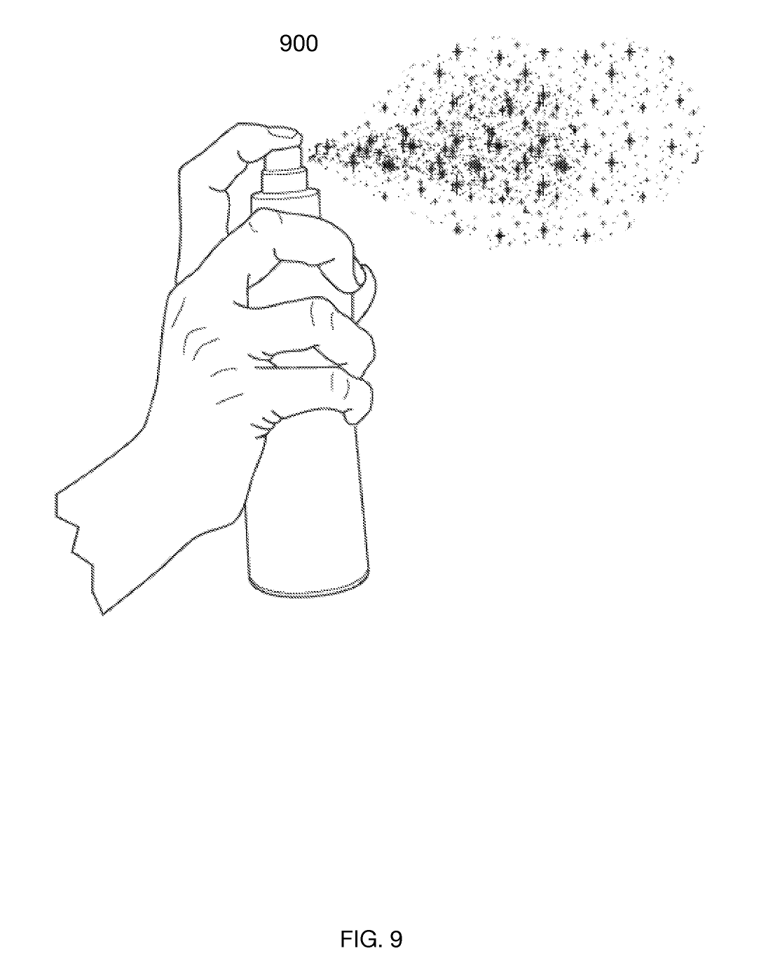

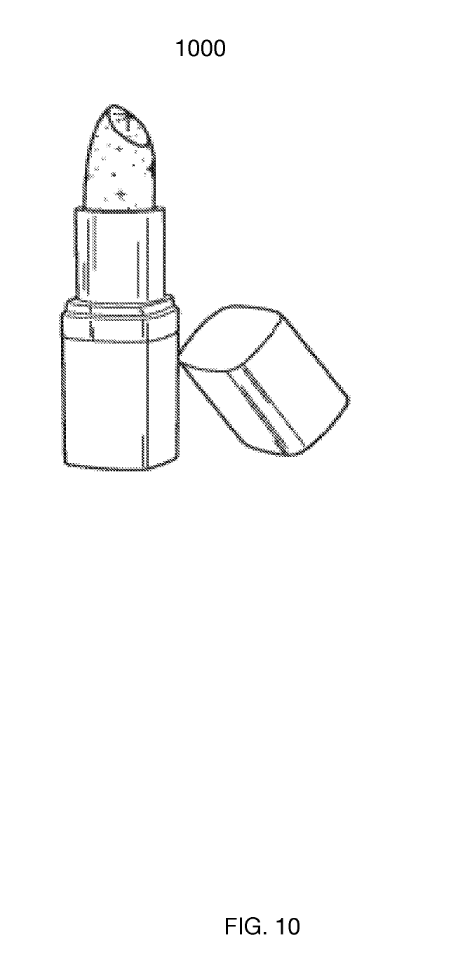

FIG. 7 shows a diagrammatic view that illustrates a woman 700 applying makeup and personal care products that contain faceted and polished diamonds. FIG. 8 shows a perspective view that illustrates body glitter 800 that contains faceted and polished diamonds. FIG. 9 shows a perspective view that illustrates hairspray 900 that contains faceted and polished diamonds. FIG. 10 shows a perspective view that illustrates lipstick 1000 that contains faceted and polished diamonds.

The woman 700 is wearing diamond-infused hairspray 702 (See FIG. 9), massacre 704, blush 706 and lipstick 708 (See FIG. 10). Makeup is applied in the ordinary way, for example, using a makeup brush 710 and compact 712. The size of the diamonds, and other characteristics are selected for incorporation into the products. For example, diamonds used in blush are sized similarity to the size of particles used in blush. Other attributes of the diamonds are selected for the desired brilliance and luminosity of the final product.

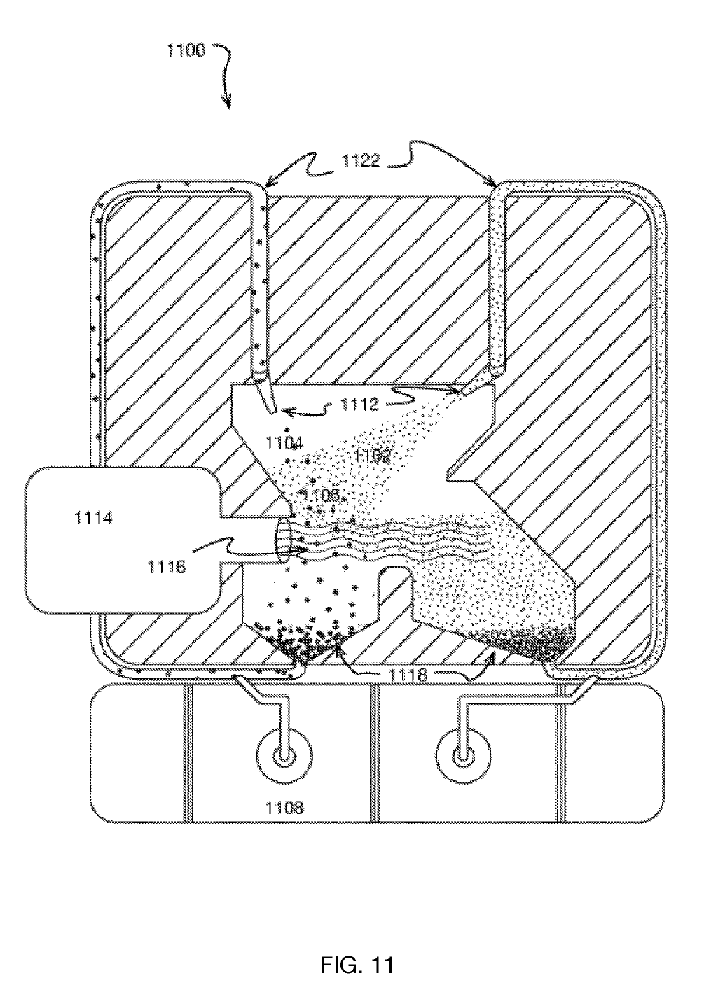

FIG. 11 shows a diagrammatic view that illustrates a diamond polishing machine that accelerates two streams of diamonds 1102 & 1104 using pneumatics such that the spray patterns overlap (in area 1106) causing the diamonds to polish. Compared to FIG. 1A, the centrifugal wheel blasters are replaced with pneumatic acceleration of the diamonds. Accordingly, this section describes differences compared to FIG. 1A. Stream 1102 consists of diamond powder that have been grown to select hardness, size, profile and other characteristics to optimize for polishing other diamond. When growing diamond powder to use as an abrasive to polish diamonds, the diamond powder is designed for abrasiveness, powder, speed of intended blasting, profile, and size. Stream 1104 consists of diamonds that have been grown to select color, clarity, size, shape, and hardness to optimize for the intended product use. In one embodiment, the diamond powder would be sized to be a fraction of the size of the diamond desired for incorporation into a commercial product; the diamond powder would be grown as harder than the diamonds to facilitate polishing; the diamond powder would have a profile effective to polish other diamonds. In one embodiment, the diamonds are grown to have a particular, regular polygonal shape. This regular polygonal shape can have relatively flat surfaces that become the “facets” of the diamond, after polishing. Said another way, diamonds can be grown such that relatively flat areas are available for polishing, without cutting the diamond. The number of relatively flat areas can also be selected through the use of appropriate diamond seeds. As used in this specification “faceted” means flat areas of diamond that occur during growth, rather than, flat areas that occur due to cutting, except where explicitly described otherwise.

Air source 1108 provides compressed, pressurized air for use in the machine, for example, air source 1108 can be an air compressor. Air source 1108 provides pressurized air at a pressure selected to accelerate the diamonds to the desired speed. Each supply tube 1122 selects a pressure suitable for the size and desired speed of the diamonds or diamond powder. The spray pattern adjusts through the nozzle 1112, as shown. These and other characteristics of spray blasting (that is, including, selecting the speed and selecting the spray pattern) are selected conventionally.

After colliding in the overlapping spray pattern area 1106, the diamond and diamond powder will fall, by gravity. An air separator 1114 pneumatically separates the larger, heavier diamond from the smaller, lighter diamond powder using a jet of air 1116. The speed of the jet of air 1116 can be selected to efficiently separate the diamond from diamond powder. The collection chambers 1118 separately collect the diamond from the diamond powder after separation, as shown. After collection, the diamonds and diamond powder return to the hoppers 1110 using conveyors, as shown, of any convenient type. Diamonds run through the machine multiple times, until the desired clarity and polish is achieved, preferably, without rounding the diamond completely.

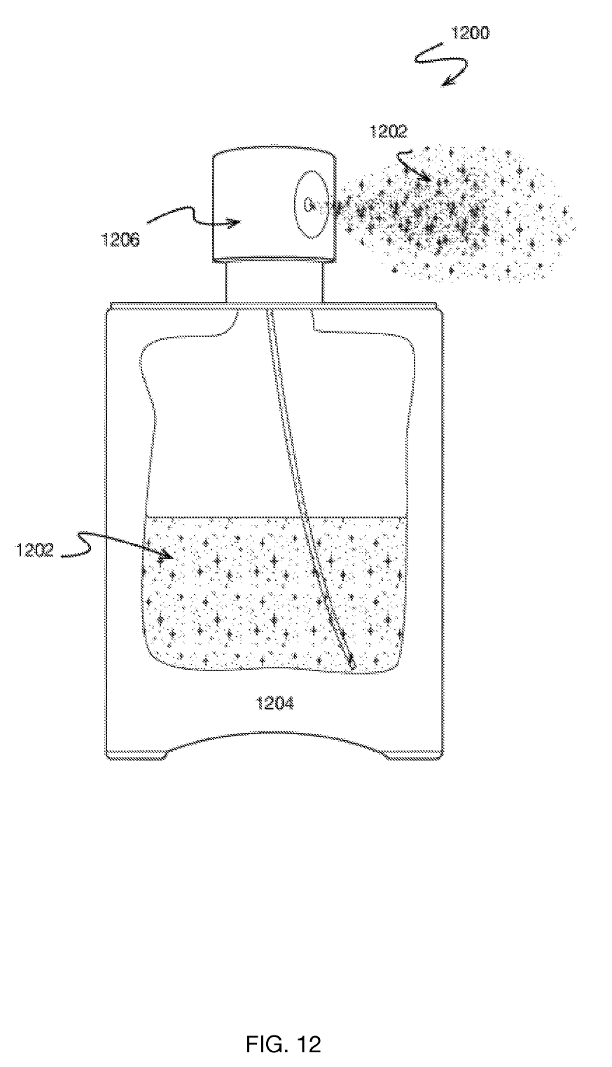

FIG. 12 shows a perspective view that illustrates perfume or cologne 1202 that contains faceted and polished diamonds. Perfume or cologne bottle 1204 includes atomizer 1206, as shown. Diamonds are sized to pass through the atomizer. In one embodiment, faceted and polished diamonds include a translucent adhesive to assist adhering to the skin.

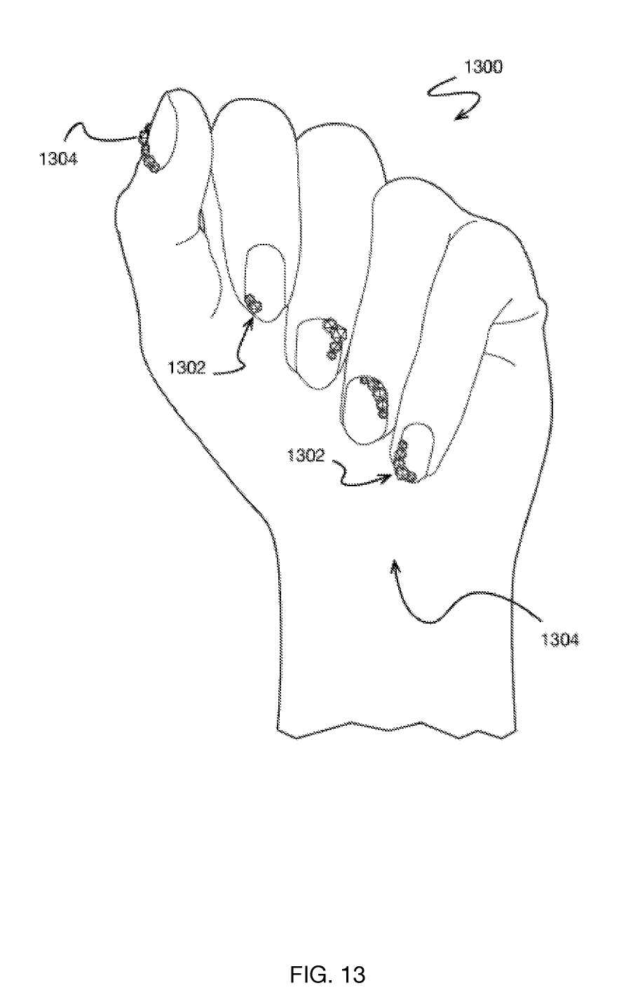

FIG. 13 shows a perspective view that illustrates finger nail art jewels 1302 that are faceted and polished diamonds having one side contoured to provide a surface for adhering to the finger nail. This hand 1304 has polished nails. The finger nail polish could include smaller diamonds, as shown in FIG. 7, however, here the finger nails are show without diamond-infused nail polish. Disposed on the polished nails are faced and polished diamonds 1302 positioned as finger nail jewel art, as shown. Diamond 1304 is shown in a side view, and, it can be seen that diamond 1304 has a flat to contoured surface suitable for adhering the diamond to the finger nail, as shown. Said another way, the fingernail art diamonds have a fasted and polished top, and, a flat-to-contoured bottom for adhering to the finger nail. Regularly symmetrical diamonds can be cut in half and contoured.

Alternately, diamonds can be grown through selection of a process that creates desired facets on one side and a flat-to-contoured surface on the other side.

Although Applicants have described Applicants' preferred embodiments of this invention, it will be understood that the broadest scope of this invention includes modifications and implementations apparent to those skilled in the art after reading the above specification and the below claims. Such scope is limited only by the below claims as read in connection with the above specification. Further, many other advantages of Applicants' invention will be apparent to those skilled in the art from the above descriptions and the below claims.

Although features and elements are described above in particular combinations, one of ordinary skill in the art will appreciate that each feature or element can be used alone or in any combination with the other features and elements. In addition, some methods described herein may be implemented in a computer program, software, or firmware incorporated in a computer-readable medium for execution by a computer or processor.

What is claimed is:

1. A method, comprising:
selecting unpolished regular-polygonal diamonds;
selecting diamond powder based on size, profile and hardness to use as acceleration media; and
polishing the regular-polygonal diamonds by accelerating at least the diamond powder using a plurality of spray patterns determined as a function of the respective hardnesses of the diamond powder and the unpolished regular-polygonal diamond, the spray patterns directed at the unpolished regular-polygonal diamonds.

2. The method of claim 1 further comprising:
accelerating the regular-polygonal diamonds and the diamond powder to create the spray patterns;
directing the spray patterns so that they overlap causing the diamond powder to polish the regular polygonal diamonds;
separating the regular-polygonal diamond from the diamond powder; and
repeating the steps of accelerating the regular polygonal diamonds and the diamond powder and the separating until the regular-polygonal diamond is polished.

3. The method of claim 1 wherein:
the accelerating uses a cylindrical wheel blaster.

4. The method of claim 2 wherein:
the accelerating uses pneumatics supplied by an air source.

5. The method of claim 1 wherein the selecting regular-polygonal diamonds includes:
using seed diamonds to create a poly shape.

6. The method of claim 5 further comprising:
selecting trace elements to determine color of the regular-polygonal diamonds.

7. The method of claim 1 wherein the accelerating the regular-polygonal diamonds and the diamond powder enables at least a portion of the diamond powder or the regular-polygonal diamonds to reach up to 300 Kelvin degrees.

8. The method of claim 1 wherein the accelerating the regular-polygonal diamonds and the diamond powder occurs in a de-pressurized area to prevent oxidation and prevent catalysis of the diamond to transition from diamond to graphite.

9. The method of claim 1 wherein the accelerating the regular-polygonal diamonds and the diamond powder velocities in meters per second of between 20 and 60.

10. A apparatus comprising:
one or more of tattoo ink, paint, lipstick, makeup, alcohol, and perfume containing polished, lab-grown, regular-polygonal diamonds.

11. The apparatus of claim 10 wherein:
the diamonds are grown to a size that is effective to reflect light.

12. The apparatus of claim 10 wherein:
the diamonds are grown to a size that is effective to adhere to the skin upon application.

13. The apparatus of claim 10 wherein:
the diamonds are grown to a size that is effective to become metabolized by human skin cells with the tattoo ink.

14. The apparatus of claim 10 wherein:
the diamonds are grown to a size that is effective to adhere with the paint upon application to a surface.
